(19) United States
(12) Patent Application Publication
(10) Pub. No.: US 2006/0079987 A1
(43) Pub. Date: Apr. 13, 2006

(54) Optimized machining controller for automatic machining device and automatic machining device with said controller

(75) Inventors: Baeg Soon Cha, Bucheon City (KR); Jin Kwal Hwang, Incheon (KR)

Correspondence Address: GREENBLUM & BERNSTEIN, P.L.C., 1950 ROLAND CLARKE PLACE, RESTON, VA, 20191, US

(73) Assignee: Korea Institute of Industrial Technology, Chonan-si (KR)

(21) Appl. No.: 11/060,285

(22) Filed: Feb. 18, 2005

(30) Foreign Application Priority Data
Oct. 8, 2004 (KR) 10-2004-80350

(51) Int. Cl. G06F 19/00

(52) U.S. Cl. 700/173

(57) ABSTRACT

Disclosed is a controller for an automatic machining device which conducts machaining of a workpiece based on NC data. The controller comprises a data input section to which NC data are inputted; a database storage section for storing optimal machining data optimized for machining conditions; an operating section for comparing the NC data and the optimal machining data and calculating optimized NC data; and a control section for controlling the automatic machining device in conformity with the optimized NC data calculated by the operating section.

### BACKGROUND OF THE INVENTION

1. Field of the invention

The present invention relates to an optimized machining controller and an automatic machining device having the controller, and more particularly to an optimized machining controller which is capable of controlling the machining work of an automatic machining device based on optimized NC data and an automatic machining device having the controller.

2. Description of the Prior Art

As generally known in the art, such an automatic machining device as a CNC lathe, a machining center, etc. are being used. Among advantages of the automatic machining device are that a workpiece can be automatically machined into a desired shape with no need for separate manipulation of the device, when NC data corresponding to drawings of the workpiece drawn with a CAD system are inputted or NC data corresponding to the desired shape of the workpiece are manually inputted into a control section of the automatic machining device. For this reason, the automatic machining device has been widely used, specifically in a field where high machining speed and high precision are required.

The CNC lathe is mainly used for cutting work, and the machining center is mainly used for complicated machining work including cutting, boring, milling, drilling, and so forth. Both of the CNC lathe and machining center have a common feature in that each of them comprises a movable section linearly displaceable in the direction of x, y and z axes and rotatable and a control section for controlling the movable section. Therefore, hereafter, a term, “automatic machining device” will be used to indicate not only the CNC lathe and machining center but also other automatic machining devices.

Generally, an automatic machining device includes a body section and a control section.

The body section has a palette on which a workpiece is fixed, a tool for machining the workpiece, and a tool operating part for moving the tool in the direction of x, y and z axes and rotating it.

The control section is usually installed adjacent to the body section, and controls the tool operating part, based on numerical data (hereinafter, referred to as “NC data”) inputted from an external source, so that the tool machines the workpiece.

FIG. 1 is a block diagram illustrating workflow in a conventional automatic machining device.

As shown in FIG. 1, initially, a designer prepares, using a CAD system, drawings of the workpiece, for example, a mold, to be machined by the automatic machining device.

Thereafter, the prepared CAD drawings are inputted into an NC data generating unit, wherein the inputted CAD drawings ate calculated and modified into NC data essential for machininga the workpiece and the NC data are inputted into the control section.

As the NC data generating unit, a computer installed with an application program is usually used and the application program calculates the NC data from the CAD drawings.

The NC data includes such information as the number of machining paths for machining the workpiece, a number of coordinate points on which the tool is positioned in the respective machining paths, feed speed of the tool, a type of the tool, an rpm of the tool, etc. The machining paths may have several or several tens of paths according to the shape of a workpiece.

The control section controls the tool operating part based on the NC data to complete the workpiece having a final shape.

Hereafter, problems caused in the conventional automatic machining device will be described with reference to FIGS. 2a and 2b.

FIG. 2a shows a perspective view illustrating a state in which a tool T of an automatic machining device machines a workpiece M in one machining path. FIG. 2b shows a cross-sectional view of FIG. 2a.

As can be readily seen from the drawings, in the illustrated machining path, the tool T is horizontally moved in the direction of x axis, y axis and x axis again. While being horizontally moved in the respective axes, the tool T cuts the workpiece M by width w1 and depth d1, width w2 and depth d2, and width w3 and depth d3, respectively.

Therefore, it is to be understood that, in the illustrated machining path, the width and depth by which the workpiece M is cut change as the moving direction of the tool T varies (in the drawings, w2>w1, w3 and d2>d1, d3), thus the load applied to the tool T changes, as well.

Though not shown in the drawings, the load applied to the tool T changes depending upon the cutting direction of the tool T, for example, the load applied to the tool T changes depending upon whether cutting is carried out in an upward or a downward direction in the z axis. Further, when the tool T cuts an inclined portion of the workpiece M, a load applied to the tool T changes depending upon the inclination angle of the inclined portion.

It is preferred that the feed speed of the tool T be determined according to the machining condition (for example, cutting width, depth, etc.), that is to say, it is preferred that, when a load applied to the tool T is large, the feed speed of the tool T be decreased, and when a load applied to the tool T is small, the feed speed of the tool T be increased.

Further, it is preferred that, even when the tool T cuts the workpiece M by the same width and depth, the feed speed of the tool T be adjusted depending upon the type of the tool T, the material of the workpiece M, etc.

However, in the conventional automatic machining device, the feed speed of the tool T was not adjusted according to the machining condition (such as a width, a depth, an inclination, a cutting direction, the tool type, the material of a workpiece, etc.). Instead, it was set to a predetermined constant value.

Therefore, in the conventional art, since machining work was conducted by moving the tool T at the constant feed speed, not only machining of the workpiece M was not sufficiently carried out or a machining precision was degraded in a position where a large load is applied to the tool T, but also the service life of the tool T was shortened due to large shock applied to the tool T. Consequently, it was necessary for a worker to manually adjust the feed speed of the tool T in a workshop.

### SUMMARY OF THE INVENTION

Accordingly, the present invention has been made to solve the above-mentioned problems occurring in the prior art, and the object of the present invention is to provide an optimized machining controller which controls machining work based on NC data optimized for a machining condition at each position on a workpiece, thereby preventing the machining precision from being degraded due to insufficient machining by a machining tool and a service life of a tool from being shortened due to shock applied to the tool, and obviating the need of posting a worker to each machining device in a workshop, and an automatic machining device having said controller.

In order to achieve the above object, according to one aspect of the present invention, there is provided a controller for an automatic machining device which carries out machining of a workpiece based on NC data, comprising: a data input section to which NC data are inputted; a database storage section wherein machining data optimized for machining conditions are stored; an operating section which compares the NC data and the optimal machining data and calculates optimized NC data; and a control section which controls the automatic machining device according to the optimized NC data calculated by the operating section.

According to another aspect of the present invention, there is provided an automatic machining device having the controller.

### BRIEF DESCRIPTION OF THE DRAWINGS

The above and other objects, features and advantages of the present invention will be more apparent from the following detailed description with reference to the accompanying drawings, in which:

FIG. 1 is a block diagram illustrating workflow in a conventional automatic machining device;

FIGS. 2a and 2b show a perspective view and a cross-sectional view illustrating a state in which a tool of the automatic machining device machines a workpiece, respectively;

FIG. 3 is a block diagram illustrating workflow in an automatic machining device having an optimized machining controller in accordance with the present invention; and

FIG. 4 is a block diagram of the optimized machining controller of FIG. 3.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the corresponding components with those of the conventional art, and repetition of the description on the corresponding components will be omitted.

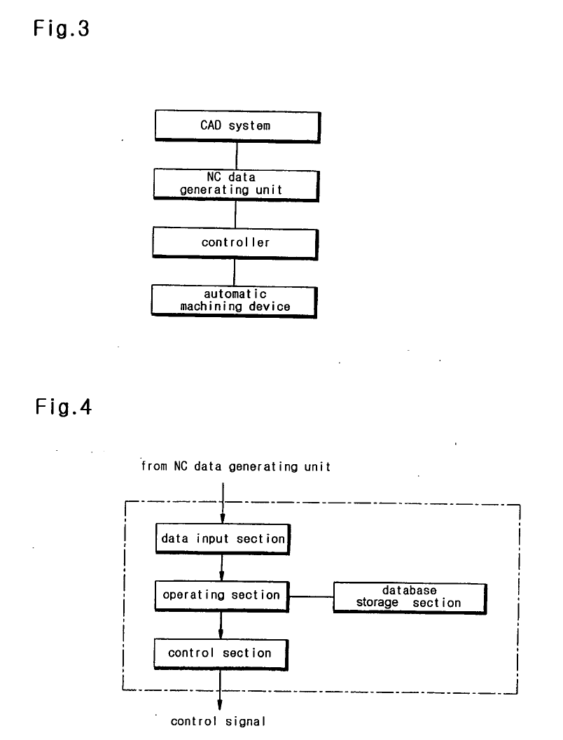

FIG. 3 is a block diagram illustrating workflow in an automatic machining device having an optimized machining controller in accordance with an embodiment of the present invention; and FIG. 4 is a block diagram illustrating a construction of the optimized machining controller of FIG. 3.

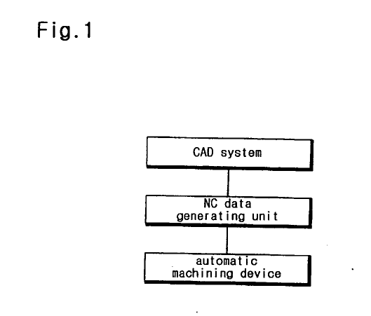

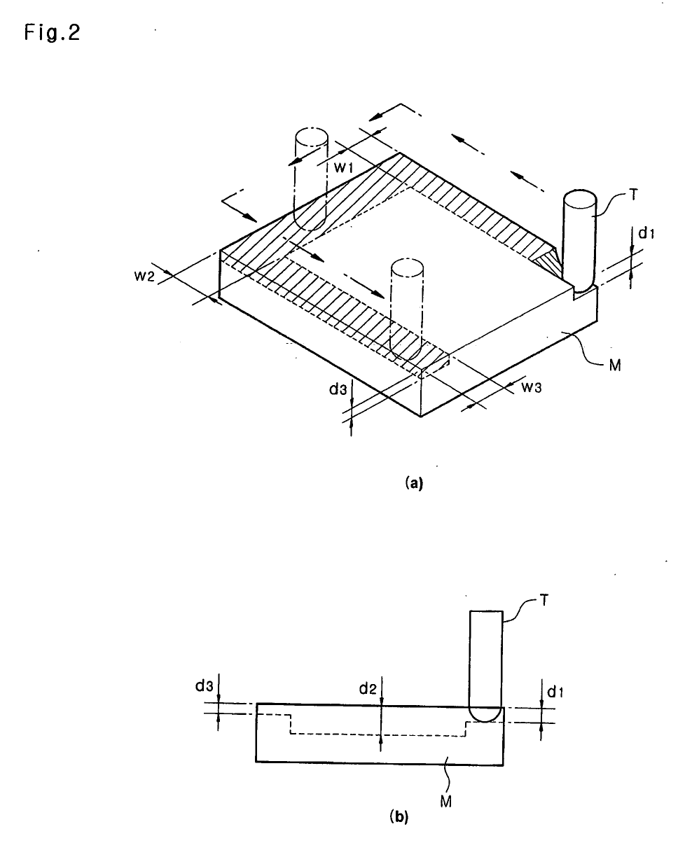

As shown in FIG. 3, workflow in an automatic machining device in accordance with an embodiment of the present invention is the same as the workflow (see FIG. 1) in the conventional automatic machining device, with an exception that a procedure by an optimized machining controller is added, so detailed descriptions for the same constitution and operation will be omitted herein.

Though a specific position where the optimized machining controller is installed is not illustrated in the drawing, it is to be readily recognized that the optimized machining controller can be formed integrally with the automatic machining device or separately from the automatic machining device to be compatible with various kind of automatic machining devices.

As shown in FIG. 4, the optimized machining controller includes a data input section, a database storage section, an operating section connected with the data input section and the database storage section, and a control section connected with the operating section.

The data input section comprises a memory such as a RAM, wherein NC data generated by an NC data generating unit is inputted to the data input section and then outputted to the operating section.

The database storage section also comprises a memory such as RAM, wherein machining data for respective machining conditions are stored as a database.

The database includes information of the feed speed of a tool, that is to say, the feed speeds of the tool are calculated in such a manner that the smallest loads is applied to the tool and a machining amount of the workpiece is maximized, in advance under various machining conditions of possible combinations of machining parameters such as cutting amount (including width, depth, etc.), the tool type, shape of a portion to be machined, material of a workpiece, etc., and stored as database with other machining parameters.

Speaking in a more detailed way, as for the cutting amount, the load applied to the tool changes depending upon whether the width and depth cut by the tool are large or small. And, as for the type of tool, the load applied to the tool changes depending upon whether the tool is a cutting tool or a milling tool and whether the size of the tool is large or small. And as for the shape of a portion to be machined, when conducting the machining of a portion of the workpiece where a contour of the workpiece abruptly varies(for example, abrubltly curved part or edged paer) the moving direction of the tool varies abruptly, thereby the load applied to the tool increases, whilst when conducting the machining of a straight or smoothly curved portion of the workpiece, the load applied to the tool decreases. Moreover, as for the material of the workpiece, a load applied to the tool decreases when the workpiece is made of a soft material such as soft steel and etc., whilst it increases when the workpiece is made of a hard material such as high-carbon steel and etc. Hence, optimal feed speeds of the tool, which cause the smallest loads applied to the tool and a maximum machining amount of the workpiece are calculated in advance for possible combinations of the above mentioned parameters of respective machining conditions (including a cutting amount, the type of the tool, the shape of a portion to be machined, material of a workpiece, etc.) by way of known method such as FEM and etc., and stored with other machining parameters as a database in the database storage section. The optimal machining data is recalled by the operating section and outputted to it.

The operating section comprising an operating unit such as a microprocessor and the like, analyzes the NC data inputted from the data input section, and recalls the data stored in the database storage and compares both of the data and decides whether both data are identical to each other when the recalled data are not identical to the NC data, the next data in the database storage section are recalled and compared repeatedly until the identical data are found, which are defined as optimized NC. In this way, the operating section calculates optimized NC data and outputs the optimized NC data to the control section.

Speaking in a more detailed way, the NC data inputted from the data input section are numerical expression of the data such as the number of machining paths, coordinate points on which the tool is to be positioned in the respective machining paths (each machining path is defined by connecting the coordinate points), rpm of the tool, the type of tool, material of the tool, etc. The operating section analyzes the inputted data and repeatedly compares the data with the data stored in the inputted database storage section, until the data stored in the database storage section that are identical to the inputted data are found.

The found optimized NC data (including the optimal feed speed of the tool) which are appropriated to each machining condition, are then outputted to the control section. Namely, the NC data is corrected into optimized NC data while passing through the operating section.

The control section corresponding to the control section of the conventional automatic machining device controls the tool operating part based on the optimized NC data as the optimized NC data is outputted to the control section.

While in the above mentioned preferred embodiment of the present invention, the data input section, the operating section and the control section are described to be a separate member, respectively, it can be envisaged that the data input section and the operating section are integrally formed, or the operating section and the control section are integrally formed or the data input section, the operating section and the control section are integrally formed, that is, the scope of the present invention is not limited to the case in which the sections are separate members.

Describing operations of the embodiment, CAD drawings of a workpiece having a desired shape to be machined, drawn by a designer, are converted into NC data in the NC data generating unit. Then the NC data are inputted to the data input section, and the operating section analyzes the NC data, compares that with data stored in the database storing section, calculates the optimized NC data, and outputs the optimized NC data to the control section.

On input of the optimized NC data, the control section controls the tool operating part based on the optimized NC data to complete the workpiece having the desired shape.

As apparent from the above descriptions, the optimized machining controller and the automatic machining device having the controller according to the present invention provide advantages as follows:
Since machining work is performed based on optimized NC data, it is possible to prevent a machining precision from being degraded due to insufficient machining and a service life of a tool from being shortened due to shock applied to the tool.
Further, because the need of posting a worker to each machining device in a workshop can be obviated, a producing cost can be lowered.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A controller for an automatic machining device which carries out machining of a workpiece based on NC data, comprising:
a) a data input section to which NC data are inputted;
b) a database storage section wherein machining data optimized for machining conditions are stored;
c) an operating section which compares the NC data and the machining data and calculates optimized NC data; and
d) a control section which controls the automatic machining device according to the optimized NC data calculated by the operating section.

2. An automatic machining device having the controller according to claim 1.
